(19) United States
(12) Patent Application Publication
(10) Pub. No.: US 2024/0301924 A1
(43) Pub. Date: Sep. 12, 2024

(54) DUCT VALVE FOR CLUTCH ASSEMBLY IN OFF-ROAD VEHICLES

(71) Applicant: Arctic Cat Inc., Thief River Falls, MN (US)

(72) Inventor: David Vigen, Thief River Falls, MN (US)

(21) Appl. No.: 18/426,148

(22) Filed: Jan. 29, 2024

Related U.S. Application Data
(60) Provisional application No. 63/450,578, filed on Mar. 7, 2023.

(51) Int. Cl. F16D 48/02; F16K 27/02

(52) U.S. Cl. CPC F16D 48/02; F16K 27/0245; F16D 2048/029; F16D 2300/021

(57) ABSTRACT

The present disclosure relates to a duct valve for a clutch assembly of an off-road vehicle. The duct valve is configured to be coupled to a housing of the clutch assembly. The duct valve comprises a first duct attached to the housing and a first valve cage attached to the first duct. The first valve cage is configured to hold a first floatable element therewithin. The first floatable element is configured to have a first buoyancy and is configured to displace towards a first air opening of the first duct corresponding to a level of a liquid to seal the first air opening.

### PRIORITY CLAIM

This application claims the benefit of priority from U.S. Provisional Patent Application No. 63/450,578, filed Mar. 7, 2023, the contents of which are incorporated herein by reference.

### FIELD OF THE DISCLOSURE

The present disclosure generally relates to off-road vehicles. More particularly, the present disclosure relates to cooling duct valves for clutch assemblies in the off-road vehicles.

### BACKGROUND

All-terrain (ATV) and side-by-side (UTV) off-road vehicles typically transfer power from the engine to the transmission through the use of a continuously variable transmission (CVT). In other words, the CVT provides a drive-system linkage between the engine and transmission of the vehicle to then send torque to the wheels of the vehicle. The CVT clutch assembly generally includes a primary clutch, a secondary clutch, and a belt between the primary clutch and the secondary clutch. The primary clutch is coupled with the engine crankshaft and the secondary clutch is coupled with the input shaft of the transmission or the transaxle of the vehicle. Each of the primary clutch and the secondary clutch includes a stationary sheeve and a movable sheeve. The movable sheeve displaces based on a received torque.

In normal operation of the vehicle, the engine power rotates the first clutch. The torque received in the first clutch is transferred to the second clutch using a belt when the first clutch reaches a specific value of revolutions per minute or through the use of an intermediate centrifugal clutch. In case of acceleration, as the speed increases, the movable sheeve of the primary clutch moves closer to the stationary sheeve, and the movable sheeve of the secondary clutch displaces away from the stationary sheeve thereof. In case of deceleration, the movable sheeve of the primary clutch displaces away from the stationary sheeve and the movable sheeve of the secondary clutch displaces towards the stationary sheeve thereof. All such displacements also depend on the torque (or load) applied to the primary clutch as well. The operation of acceleration and deceleration as well as loading and unloading cause continuous rubbing of the belt with the sheeves, thereby generating heat in CVT clutch assembly.

All the CVT clutch assemblies are designed to work on specific parameters, such as, specific load, engine power, and speed. Change in any of such parameters exerts load on the CVT clutch assembly. Many times, users/owners of the off-road vehicles change different components. For instance, the users may replace the original tires with the tires having bigger size. Similarly, turbos, clutch springs and weights and other modifications may be employed that may alter the performance of the vehicle. Such altered power delivery also exerts altered loads on the CVT clutch assembly, thereby potentially causing additional heat generation between the belt and clutch sheaves.

Due to heat build-up, air cooling is typically provided to a CVT clutch assembly. The CVT clutch assembly mainly includes the primary and secondary clutches, the belt between the clutches, a housing for the clutch, and a cooling arrangement. The cooling arrangement may include an inlet duct and an exhaust duct to intake and exhaust the atmospheric air in and out of the CVT clutch assembly, respectively. Inlet and exhaust openings of the inlet and exhaust ducts, respectively, are generally kept above and over the engine assembly because of limited space available around engine assembly in the vehicle and to keep water from entering the ducts. Sometimes, such off-road vehicles operate in a wet environment with possibilities of passing of liquid in off-road vehicles, such as when the vehicles pass through streams or muddy trails. In such cases, it is important to prevent or at least restrict passing of water (clean or muddy) within the CVT clutch assembly to avoid slippage of and damage thereto.

Different modifications are being made while designing cooling arrangements for off-road vehicles that provide cooling of the clutch and restrict water from reaching the inside of the clutch assembly.

### SUMMARY OF THE DISCLOSURE

The present disclosure sets forth a duct valve for a continuously variable transmission (CVT) clutch assembly in an off-road vehicle. The clutch assembly includes a housing having a cover. The duct valve comprises a first duct and a first valve cage. The first duct is coupled to the housing of the clutch assembly. The first valve cage is coupled to the first duct and comprises a first peripheral surface having at least one first side opening. The first valve cage further comprises a first top surface and is configured to comfortably hold a first floatable element therewithin, to provide a displacement of the first floatable element between the first top surface and the first bottom surface thereof.

The duct valve further comprises a second duct coupled to the housing. The second duct is coupled to a second valve cage defined by a second bottom surface, such that the second bottom surface is closer to the ground than the first bottom surface of the first valve cage of the first duct. The second valve cage includes a second top surface and is configured to hold a second floatable element to provide displacement of the second floatable element between the second bottom surface and the second top surface.

The first floatable element and the second floatable element are configured to have a first buoyancy and a second buoyancy, respectively. The first floatable element and the second floatable element are configured to displace towards the first top surface of the first valve cage and the second top surface of the second valve cage, respectively, according to a liquid level when the clutch assembly is partially in a liquid medium. Particularly, the first floatable element and the second floatable element are configured to completely cover the first air opening and the second air opening when the clutch assembly is completely within the liquid medium. In approaching such clutch-immersed condition, the second floatable element is configured to be displaced to the second top surface covered before the first air opening.

The present disclosure further sets forth an off-road vehicle having an engine assembly, a CVT clutch assembly having a housing, and a duct valve for the clutch assembly. The duct valve comprises a first duct, a first valve cage having a first peripheral surface, a second duct, and a second valve cage having a second peripheral surface. The first valve cage is configured to hold a first floatable element, and the second valve cage is configured to hold a second floatable element. The first side opening is configured to extend lower than the second side opening. The first floatable element and the second floatable elements are configured to have a first buoyancy and a second buoyancy, respectively. The first floatable element and the second floatable element are configured to be displaced towards a first top surface of the first valve cage and a second top surface of the second valve cage, respectively, according to a liquid level when the first valve cage and the second valve cage, respectively, is partially submerged in a liquid medium.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures.

FIG. 1 is an exemplary perspective view of an off-road utility vehicle in accordance with the present disclosure.

FIG. 2 illustrates an exemplary isometric view of a frame and an engine assembly of an off-road vehicle having a duct valve connected to a clutch housing in accordance with the present disclosure.

FIGS. 3A, 3B, and 4 illustrate an exemplary rear-elevational view, cross-sectional view, and an isometric view, respectively, of a first duct and a first valve cage of a clutch assembly of an off-road vehicle in accordance with the present disclosure.

FIG. 5 illustrates an exemplary rear view of a duct valve of a clutch assembly having a first duct, a first valve cage, a second duct, and a second valve cage of a clutch assembly of an off-road vehicle in accordance with the present disclosure.

FIG. 6 illustrate an exemplary side view of a clutch assembly with a duct valve of an off-road vehicle in accordance with the present disclosure.

FIGS. 7-8 illustrate a first side view and a second side view showing of a first duct and a first valve cage and a second duct and a second duct cage, respectively, of an off-road vehicle according to an embodiment of the present disclosure.

FIG. 9 illustrates an exemplary top isometric view of an engine area having a second duct and a second valve cage in an off-road vehicle according to an embodiment of the present disclosure.

FIG. 10 illustrates an exemplary top isometric view of an engine area having a first duct, a first valve cage, a second duct and second valve cage of a clutch assembly in an off-road vehicle according to an embodiment of the present disclosure.

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Embodiments of the present disclosure describe an off-road vehicle having different features such as a frame structure, an engine assembly, a continuously variable transmission (CVT) clutch assembly, and a suspension assembly. The term ‘engine assembly’ may refer to an engine of an off-road vehicle and associated parts. The CVT clutch assembly may comprise a primary clutch, a secondary clutch, a belt between the primary clutch and the secondary clutch, and a housing having a cover. The vehicle may include a duct valve for providing cooling to the clutch. Components described herein are not limited to off-road vehicles and may be utilized for different vehicles. For example, the duct valve of the clutch assembly may be used in different models of on-road or off-road vehicles for providing cooling and for preventing entering of liquid in the clutch assembly. In addition, the duct valve may be utilized in remotely operated underwater vehicles (ROV) for preventing entering of liquid in the clutch assembly.

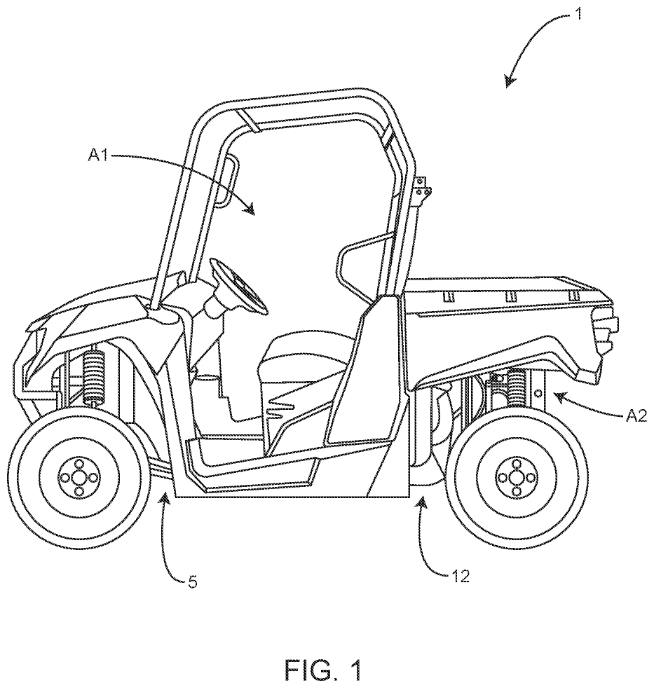

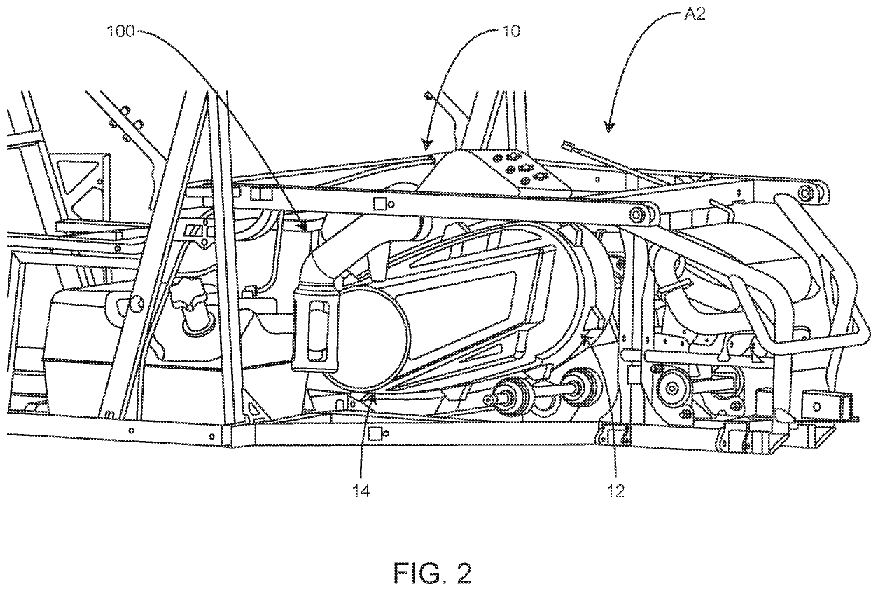

Reference is now made to FIG. 1, which represents an off-road vehicle 1 according to some embodiments of the present disclosure. The vehicle 1 generally includes a frame 5 that extends from a front part of the vehicle 1 to a rear part thereof. The frame 5 may include different structures and may be configured to be divided to generally define different areas of the vehicle 1. For instance, the frame 5 may be divided into two parts. A front part of part of the frame 5 may define a seating area A1. The seating area A1 of the vehicle 1 comprises a steering assembly of the vehicle 1, corresponding components, and one or more seats for providing seating to one or more riders. The rear part of the frame 5 may include an engine area A2 and may provide support to different assemblies. The engine area A2 may be configured to receive an engine assembly 10 and a continuously variable transmission (CVT) clutch assembly 12 of the vehicle 1 (seen e.g., in FIGS. 1-2).

The CVT clutch assembly 12 may include a duct valve 100 for providing cooling to the clutch and to restrict liquid, such as water or muddy water from entering within the CVT clutch assembly 12 (seen e.g., in FIG. 2). Specifically, the duct valve 100 may be configured to be fluidly communicate with a housing 14 of the clutch assembly 12. In some embodiments, the housing 14 may include a cover for the clutch assembly 12. The cover may include an inner cover, an intermediate cover, and an outer cover. In some embodiments, the duct valve 100 may be attached to the inner cover. Optionally, the duct valve 100 may be attached to the intermediate cover.

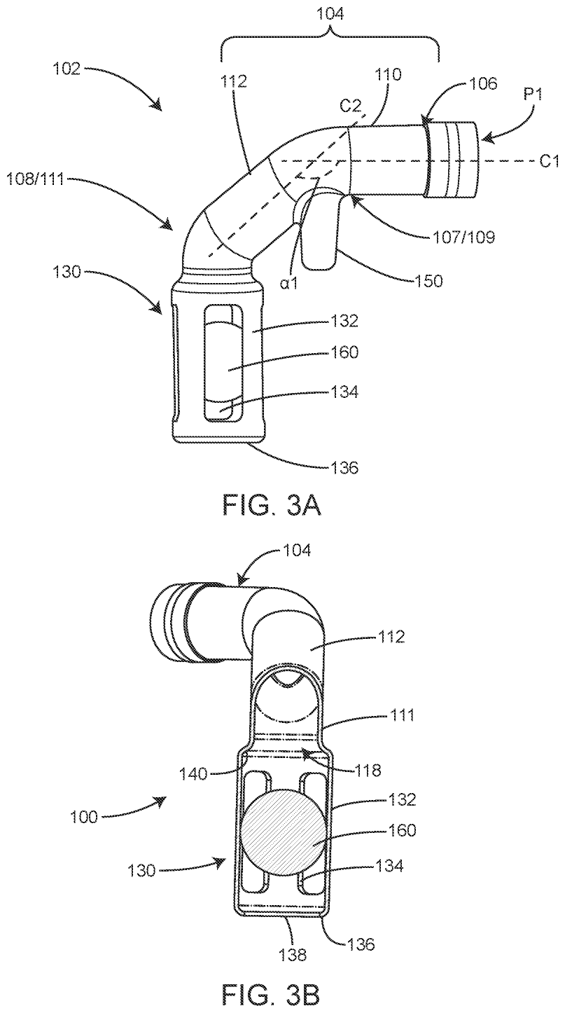

Reference is now made to FIGS. 3A and 3B, which illustrate an exemplary rear view and cut-away view, respectively, of the duct valve 100 in accordance with the present disclosure. The duct valve 100 may include a first duct 104 and a first valve cage 130. The first duct 104 may extend to a first side of the vehicle 1 from the inner cover of the housing 14. The first side may be defined as an outer side towards an outer side of the clutch assembly 12. The first duct 104 may be defined by a first end 106 and a second end 108. The first end 106 may be attached to the housing 14 and the second end 108 may be attached to the first valve cage 130.

In some embodiments, the first duct 104 may include a first part 110 and a second part 112 (seen e.g., in FIG. 3A). The first part 110 may be attached to the housing 14 at the first end 106 thereof. In some embodiments, the first end 106 may be attached to a provision P1 of the housing 14 for attachment of the first duct 104 thereto using one or more fasteners. Optionally, the first end 106 may be configured to be received completely within the provision P1 such as to provide a tight fit therewith. The first part 110 is attached to the second part 112 at an intermediate end 109 thereof. The second part 112 may be defined by a proximal end 107 attached to the intermediate end 109 of the first part 110 and a distal end 111 attached to the first valve cage 130 (seen e.g., in FIGS. 3A, 3B). Accordingly, the second end 108 of the first duct 104 and the distal end 111 of the second part 112 may represent the same end.

In some embodiments, the distal end 111 of the second part 112 may be configured to constitute a first air opening 118 (seen e.g., in FIG. 4). The first air opening 118 may facilitate inlet of air from the first duct 104 to an interior of the housing 14, thereby providing cooling air for the clutch. Alternatively, a similar arrangement may be used for the exhaust of air from the CVT housing. The cage 130, while positioned differently, may be similar including its connection to the duct.

The first duct 104 may be a circular pipe and may be defined by a circular cross-section. Accordingly, the first part 110 and the second part 112 may be defined by circular cross-sections and may be configured to have a first central axis C1 and a second central axis C2, respectively (seen e.g., in FIG. 3A). The first central axis C1 and the second central axis C2 may be configured to pass through a first centre and a second centre, respectively, of the first part 110 and the second part 112. The first part 110 may have a first diameter and a second part 112 may have a second diameter. In an embodiment, the first diameter is equal to the second diameter, thereby providing tight connection between the first part 110 and the second part 112. In an embodiment, the first part 110 and the second part 112 may be coupled or integrally manufactured to form a single element.

In some embodiments, the first part 110 and the second part 112 are attached to each other such that the second central axis C2 is positioned at least at a first angle α1 with the first central axis C1 (seen e.g., in FIG. 3A). The first angle α1 may be an obtuse angle. Accordingly, the first duct 104 extends towards the ground from the second part 112 thereof. Such arrangement of the first duct 104 utilizes less space in the engine area and prevents entering of liquid within the CVT clutch assembly 12 therefrom as the liquid flows down due to the inclination of the second part 112.

The first valve cage 130 may be configured to be coupled to the distal end 111 of the second part 112 of the first duct 104 and may include a first peripheral surface 132, a first top surface 140, and a first bottom surface 136 (seen e.g., in FIGS. 3B, 4). The first top surface 140 may be coupled to the distal end 111 of the second part 112 of the first duct 104. The first top surface 140 preferably includes a contour that matches the contour of a first floatable element 160 for creating a good seal between the two. The first top surface 140 may be configured to have a top opening corresponding to the first air opening 118 of the first duct 104. The top opening corresponds to the second diameter of the second part 112 of the first duct 104. In other words, the second diameter is equal to the top opening. In some embodiments, a cross-section of the second part 112 is less as compared to a cross-section of the first valve cage 130.

The first peripheral surface 132 of the first valve cage 130 may be configured to have at least one first side opening 134 (seen e.g., in FIGS. 3-4). The at least one first side opening 134 may be configured to provide a passage of air from the surrounding to pass through the at least one first valve cage 130 to the interior of the clutch assembly 12 through the first air opening 118 of the first duct 104.

The first bottom surface 136 of the first valve cage 130 may be closed or may include a first bottom opening 138 (seen e.g., in FIG. 4). The first bottom opening 138 may be configured to substantially cover the first bottom surface 136 of the first valve cage 130. In other words, the first bottom surface 136 is substantially an open surface with a smaller diameter around the edge of the opening to retain the floatable element described below. The opening 138 facilitates the exit of debris from the valve cage 130.

The first valve cage 130 may be configured to hold a first floatable element 160 therewithin (seen e.g., in FIGS. 3-4). The first floatable element 160 may be configured to be displaced within the first valve cage 130 with a small clearance between the floatable element and the sides of the valve cage. In an embodiment, the first floatable element 160 may have a first buoyancy. The first buoyancy may facilitate displacement of the first floatable element 160 towards the first top surface 140 in presence of a liquid medium. At the same time, the density is selected such that the element 160 will displace from the top surface 140 of valve cage 130 even in the presence of some suction pressure as long as the liquid medium is below the floatable element 160. In an embodiment, the first floatable element 160 may displace towards the first top surface 140 according to a level of liquid relative to the first valve cage 130. In other words, when the level of liquid increases with respect to the first valve cage 130, the first floatable element 160 rises as per the level of liquid due to the first buoyancy of the floatable element 160. The first buoyancy may be selected such that the first floatable element 160 floats over the level of liquid. Hence, the first floatable element 160 displaces towards the first top surface 140 when the clutch assembly or at least the first valve cage 130 is partially disposed or submerged within the liquid medium and displaces towards to the first top surface 140 and is configured to substantially or completely seal the first air opening 118 when the valve cage 130 is nearly or completely immersed in the liquid medium. For the same, a cross-section of the first floatable element 160 is larger than the cross-section of the second part 112 of the first duct 104. Hence, when the CVT clutch assembly (or at least the first valve cage 130) is completely in the liquid medium, the first floatable element 160, due to its first buoyancy, completely covers the first air opening 118, thereby sealing the first duct 104, so as to prevent substantial entry of liquid within the CVT clutch assembly 12. Preferably, the floatable element seals off the top of the cage valve 130 before liquid completely covers the cage and even before liquid completely covers the floatable element 160. This decreases the chance of significant liquid entering the ducts. As noted above, the inner, concave contour of the top surface 140 complements the external convex contour of the floatable element 160. Thus, a portion of the top surface is preferably a concave spherical shape to match and seal with a portion of the preferred spherical floatable element 160.

It is to be noted that the first floatable element 160 is illustrated as a spherical member in the present disclosure. However, such illustration does not limit the scope of the invention and the first floatable element 160 may be of other geometrical shapes as well. For instance, the first floatable element 160 may be a cuboid or a circular, rectangular, or triangular plate having dimensions so as to substantially seal the first air opening 118. Additionally, the first floatable element 160 may be made of a deformable material such that the first floatable element 160 may be inserted within the first valve cage 130 through the first bottom opening 138 or through one of the side openings 134 by deforming, for example by squeezing.

In some embodiments, the first duct 104 may include an extension 150 (seen e.g., in FIGS. 3-4). The extension 150 may be configured to provide a support to the first duct 104. The extension 150 may be configured to rest on or be secured to an outer side of the housing 14. In an embodiment, the extension 150 may be configured to rest on an outer cover of the housing 14. The extension 150 may extend from any part of the first duct 104. For instance, the extension 150 may extend from the first part 110 or the second part 112 of the first duct 104. FIGS. 3-4 illustrate an exemplary extension 150 extending from the coupling point of the first duct 104 and the second duct 204. A length of the extension 150 may be designed as required. For instance, the length of the extension 150 may vary depending upon a location from which it is extended from the first duct 104 and a distance of that location to the housing 14. The extension 150 may be extended at any angle from the first duct 104, i.e., from the first part 110, the second part 112, or the coupling point therebetween.

It is to be noted that the first duct 104 is shown having the first part 110 and the second part 112 for illustrative purposes only and such design of the first duct 104 does not limit the scope of the invention. For instance, the first duct 104 may include a single pipe attached to the housing 14 at one end at an inclination and to the first valve cage 130 at a second end. In such design, the second end of the first duct 104 may define a first air opening and the extension 150 may extend from any location throughout the length of the first duct 104.

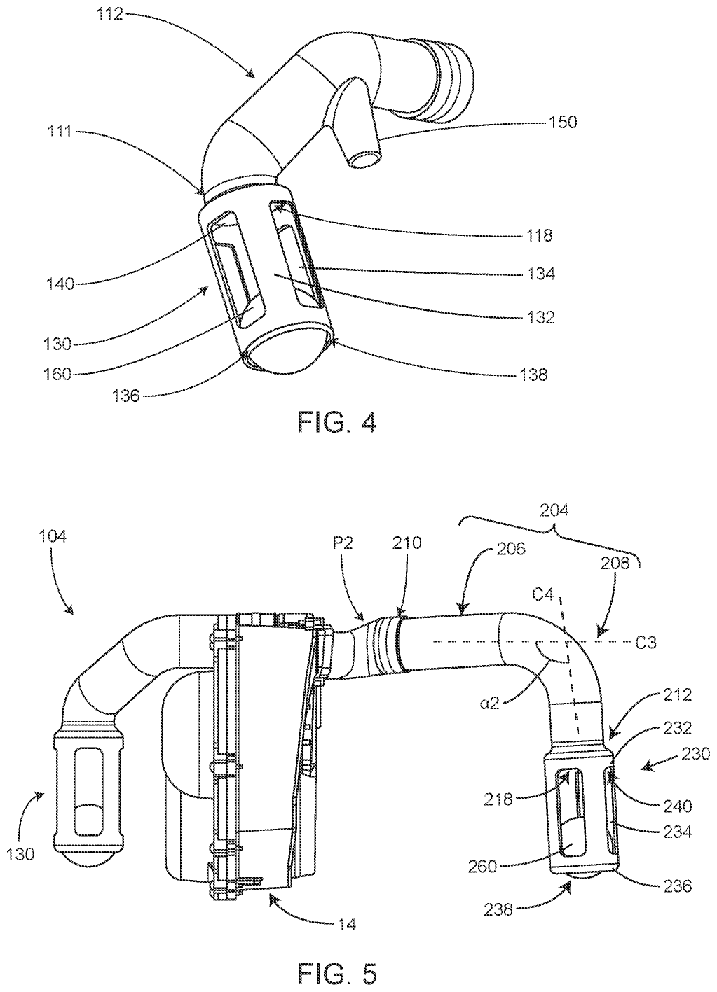

In some embodiments, the duct valve 100 may include a second duct 204 and a second valve cage 230 (seen e.g., in FIG. 5). In some embodiments, the second duct 204 may be defined by a second proximal end 210 and a second distal end 212 (seen e.g., in FIG. 5). The second duct 204 may be attached to a second provision P2 of the housing 14 at the second proximal end 210 using one or more fasteners. Optionally, the second proximal end 210 may be configured to be received completely within the second provision P2 such as to provide a tight fit therewith. The second valve cage 230 preferably has the same features as discussed above with regard to the first valve cage 130.

The second duct 204 may include a third part 206 coupled to the housing 14 and a fourth part 208 between the third part 206 and the second valve cage 230 (seen e.g., in FIG. 5). The third part 206 may be coupled with the housing 14 at the second proximal end 210 of the second duct 204 and the fourth part 208 may be coupled to the second valve cage 230 at the second distal end 212 of the second duct 204 defining a second air opening 218 (seen e.g., in FIG. 5). The second air opening 218 may be configured to exhaust the air from within the clutch assembly to the surrounding atmosphere. Hence, a path of the air within the clutch assembly 12 may be defined as intake of air from the first air opening 118 of the first duct 104 within the clutch assembly 12 and towards the second air opening 218 from the clutch assembly 12 into the atmosphere. Hence, the clutch assembly 12 may have air flow through it for cooling.

In some embodiments, the second duct 204 is configured to have a circular cross-section. Accordingly, the third part 206 and the fourth part 208 may also be of circular cross-sections. In an embodiment, the third part 206 may be configured to have a third central axis C3 and the fourth part 208 may be configured to have a fourth central axis C4 (seen e.g., in FIG. 5). The third part 206 and the fourth part 208 may be coupled to each other such that the third central axis C3 is positioned at least at a second angle α2 with the fourth central axis C4. In an embodiment, the first angle α1 between the first central axis C1 and the second central axis C2 may be less than the second angle α2 between the third central axis C3 and the fourth central axis C4. Such difference of angle between the first angle and the second angle may correspond to the position of the second duct 204 as will be described hereinbelow.

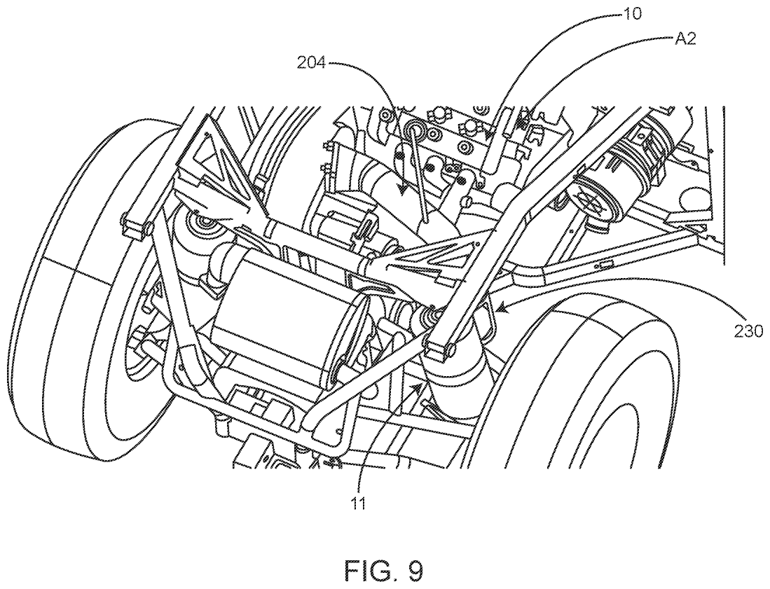

The second duct 204 may be configured to extend from a second side of the housing 14 of the clutch assembly 12. The second side may be a side opposite to the first side and towards the engine assembly 10 of the vehicle 1. In some embodiments, the second duct 204 may extend from the second side of the housing 14 of the clutch assembly 12 to proximate a rear suspension assembly 11 of the vehicle 1 (seen e.g., in FIG. 9). In such embodiments, the second duct 204 may pass over a transmission of the vehicle 1 to the second side thereof. To facilitate such extension 150 of the second duct 204 over the engine, the second angle α2 may be larger than the first angle α1. Location of the second duct 204 (cooling air exhaust duct) opening may be situated to take advantage of turbulent or otherwise low-pressure zones to help pull air through the CVT clutch assembly 12.

The second valve cage 230 may be defined by a second top surface 240, a second peripheral surface 232, and a second bottom surface 236 (seen e.g., in FIG. 5). The second top surface 240 may include a second top opening corresponding to the second air opening 218 such that, a cross-section of the second duct 204 is less than a cross-section of the second valve cage 230. The second peripheral surface 232 may include at least one second side opening 234 facilitating air exhaust from the second duct 204. The second bottom surface 236 may include a second bottom opening 238 substantially covering the second bottom surface 236. The diameter and openings of the second duct 204 (exhaust duct) may be larger than the diameter and/or openings of the first (intake) duct 104 to further promote positive flow through the clutch housing 14.

The second valve cage 230 may be configured to hold a second floatable element 260 therewithin (seen e.g., in FIG. 5). The second floatable element 260 may be configured to be displaced within the second valve cage 230. The second floatable element 260 may be configured to have a second buoyancy and may be configured to be displaced towards the second top surface 240 when the second valve cage 230 is at least partially in a liquid medium. In an embodiment, the second floatable element 260 may be configured to be displaced towards the second top surface 240 corresponding to a level of liquid in the liquid medium due to the second buoyancy. The second buoyancy of the second floatable element 260 may be selected such that the second floatable element 260 floats over the level of liquid. In the case in which the valve cage 230 is substantially immersed within the liquid medium, the second floatable element 260 covers and substantially seals the second air opening 218 of the second duct 204. In the absence of the liquid medium, the second floatable element 260 may be configured to comfortably seat on an inner side of the second bottom surface 236 as shown in FIG. 5.

It is to be noted that the second floatable element 260 is illustrated having a spherical shape in the present disclosure. However, such illustration does not limit the scope of the invention and the second floatable element 260 may be of other geometrical shapes as well. For instance, the second floatable element 260 may be a cuboid or a circular, rectangular, or triangular plate having dimensions to substantially or completely seal the second air opening 218. Further, the second floatable element 260 may be made of a deformable material such that the second floatable element 260 may conform to the opening 218 and so it may be inserted within the second valve cage 230 through the second bottom opening 238 or through a side opening 234 by deforming, for example by squeezing.

In some embodiments, the first and second valve cages 130, 230 may not have corresponding bottom openings 138, 238. In such embodiments, the first and/or the second floatable elements 160, 260, may be inserted through the corresponding top openings prior to assembly or through the corresponding at least one side opening 134, 234.

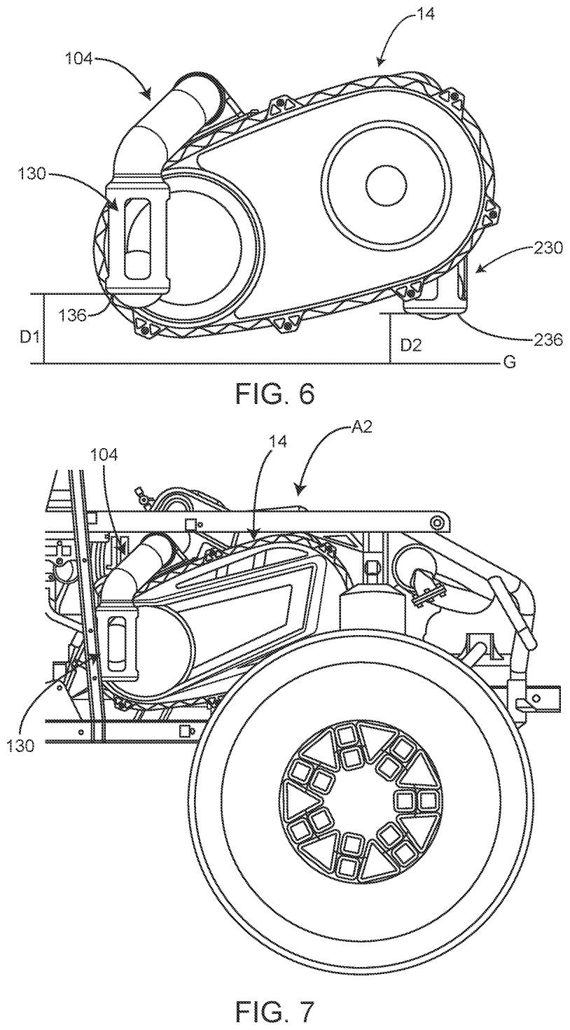

In some embodiments, the first duct 104 and the first valve cage 130, and the second duct 204 and the second valve cage 230 may be arranged such that the first bottom surface 136 of the first valve cage 130 is closer to the ground G than the second bottom surface 236 of the second valve cage 230 (seen e.g., in FIG. 6). In an embodiment, a distance D1 of the first bottom surface 136 of the first valve cage 130 from the ground G is greater than a distance D2 of the second bottom surface 236 of the second valve cage 230 from the ground G. This is in the situation where the height of the valve cages are the same such that the side openings 134, 234 are similar. Thus, the height of the tops of the side openings 134, 234 are preferably staggered. Preferably the valve that expels air opens last when exiting a liquid medium. Hence, when the clutch assembly is at least partially in a liquid medium, the second air opening 218 is covered by the second floatable element 260 before the first air opening 118. When the clutch assembly 12 further goes within the liquid medium, the first floatable element 160 covers the first air opening 118, thereby restricting intake of air and/or liquid within the clutch assembly 12. This arrangement maintains sufficient volume of the air within the clutch assembly 12 when the clutch assembly is completely within the liquid medium, and hence, prevents drawing the first floatable element 160 within the first duct 104 or the clutch assembly 12, for example by action of swallowing, due to its deformable material, as the exhaust of air is restricted first.

Similarly, when a level of liquid subsides and the cage 130 comes at least partially out of the liquid medium, the first floatable element 160 displaces away from the first top surface 140 due to the first buoyancy, thereby opening the first air opening 118 before the second air opening 218. As a result, intake of air is reinitiated from the first air opening 118. When the level of liquid further reduces, the second floatable element 260 displaces towards the second bottom surface 236, thereby opening the second air opening 218 and reinitiating exhaust of air from the clutch assembly 12 through the second air opening 218. Hence, the arrangement of the duct valve 100 as illustrated is configured to maintain air flow within the clutch assembly 12 and prevents entering any liquid in the clutch assembly when the vehicle 1 travels from a liquid medium, such as, a water stream, a muddy trail, and the like. Also, such duct valve 100 is ideal for use in a remotely operated underwater vehicles (ROV).

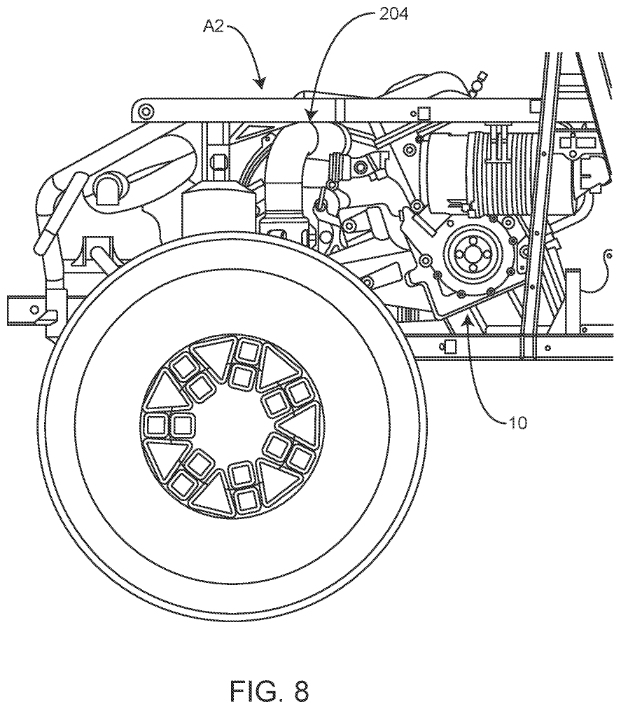

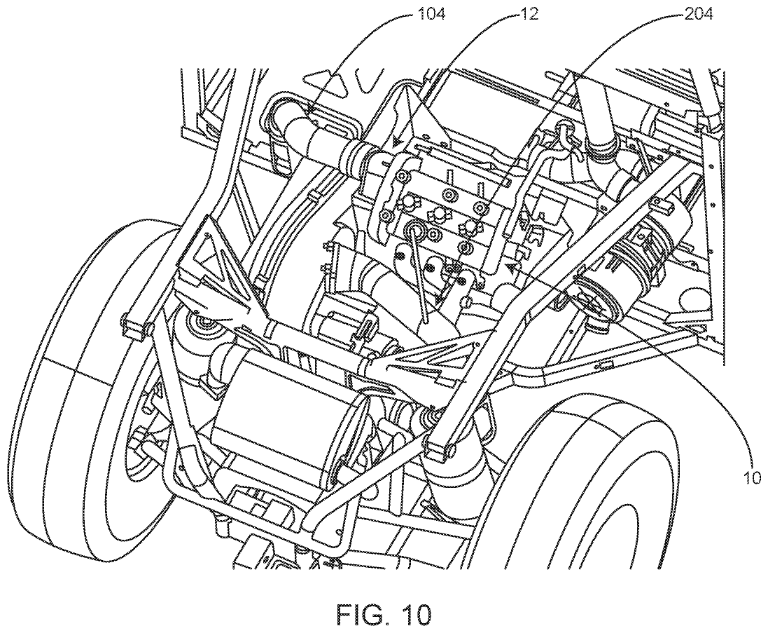

FIGS. 7-10 illustrate different views of the duct valve 100 coupled to the clutch assembly in accordance with the present disclosure. More specifically, FIG. 7 illustrates a first side-elevational view of the clutch assembly in which the first duct 104, and hence the first valve cage 130, is attached to a first side of the housing 14 (in this instance the left side), while FIG. 8 illustrates a second side view of the clutch assembly in which the second duct 204, and hence the second valve cage 230, is attached to a second side (e.g., right side), opposite to the first side, of the housing 14. FIG. 9 illustrates an exemplary top isometric view of an engine area A2 of an off-road vehicle 1 in which the second duct 204 extends over the transmission such that the second valve cage 230 is positioned adjacent to a corresponding rear suspension assembly 11 of the vehicle 1. FIG. 10 illustrates an exemplary top isometric view showing the first duct 104 at a first side and the second duct 204 at a second side of the clutch assembly 12.

It is to be noted that the duct valve 100 is illustrated using a first duct and a first valve cage and a second duct and a second valve cage. However, the duct valve 100 may include all or fewer components in different embodiments without departing the scope of the invention. For instance, in some embodiments, the duct valve 100 may include only a first duct and a first valve cage, while in other embodiments, the duct valve 100 may include only a second duct and a second valve cage.

It is to be noted that different values and parameters mentioned in the description are exemplary in nature and are not intended to bound the specification in any manner.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A duct valve for a continuously variable transmission (CVT) clutch assembly having a housing including a cover, the duct valve comprising:
a first duct configured to be coupled to the housing of the clutch assembly;
a first valve cage coupled to the first duct, the first valve cage comprising a first surface having at least one first opening.

2. The valve of claim 1, wherein the first surface is a first peripheral surface, the at least one first opening being a first side opening.

3. The valve of claim 1, wherein the first valve cage further comprises a first bottom surface having a first bottom opening, the first bottom opening substantially covering the first bottom surface thereof.

4. The valve of claim 1, wherein the valve cage includes a top opening smaller than a cross-section of the first valve cage.

5. The valve of claim 4, wherein the first valve cage is configured to comfortably hold a first floatable element therewithin, so as to provide a displacement of the first floatable element between a first top surface and a first bottom surface thereof, wherein the first floatable element is configured to have a dimension so as to cover the top opening of the valve cage.

6. The valve of claim 5, wherein the first floatable element is configured to have a first buoyancy so as to displace towards the first top surface of the first valve cage according to a liquid level when the first valve cage is at least partially submerged in a liquid medium.

7. The valve of claim 5, wherein the first floatable element is configured to cover a first air opening when the first valve cage is completely in the liquid medium, thereby preventing entering of the liquid within the clutch assembly from the first duct.

8. The valve of claim 7, wherein a top surface of the first valve cage is contoured to complement the shape of the first floatable element.

9. The valve of claim 2, further comprising a second duct coupled to the housing, the second duct coupled to a second valve cage defined by a second side opening, wherein a top of the second side opening is positioned vertically lower than the top of the first side opening of the first valve cage extending from the first duct.

10. The valve of claim 9, wherein the second valve cage comprises a second peripheral surface having at least one second side aperture and a second top surface coupled to the second duct, wherein the second valve cage is configured to comfortably hold a second floatable element therewithin so as to provide a comfortable displacement of the second floatable element therewithin, wherein the second floatable element is configured to have a second buoyancy so as to be displaced towards the second top surface according to a liquid level when the clutch assembly is at least partially in a liquid medium.

11. The valve of claim 9, wherein the second duct is defined by a second proximal end coupled to the housing and a second distal end coupled to the second valve cage and configured to provide a second air opening, and wherein the second floatable element is configured to substantially cover the second air opening when the clutch assembly is substantially immersed in a liquid medium, thereby preventing substantial entry of the liquid within the clutch assembly from the second duct.

12. A duct valve for a continuously variable transmission (CVT) clutch assembly having a housing including a cover, the duct valve comprising:
a first duct;
a first valve cage coupled to the first duct, the first valve cage comprising a first peripheral surface having at least one first side opening;
a second duct; and
a second valve cage coupled to the second duct, the second valve cage comprising a second peripheral surface having at least one second side opening.

13. The duct valve of claim 12, wherein the top of the second side opening of the valve cage is vertically lower than the first side opening of the first valve cage.

14. The valve of claim 12, wherein each of the first valve cage and the second valve cage comprises a first bottom surface and a second bottom surface, respectively, the first bottom surface having a first bottom opening substantially covering the first bottom surface and the second bottom surface having a second bottom opening substantially covering the second bottom surface.

15. The valve of claim 12, wherein the first valve cage is configured to hold a first floatable element and the second valve cage is configured to hold a second floatable elements, wherein the first floatable element and the second floatable element are configured to have a first buoyancy and a second buoyancy, respectively, the first floatable element and the second floatable element configured to displace towards a first top surface of the first valve cage and a second top surface of the second valve cage, respectively, according to a liquid level when the clutch assembly is partially in a liquid medium.

16. The valve of claim 15, wherein the first floatable element and the second floatable element are configured to completely cover the first air opening and the second air opening when the clutch assembly is completely within the liquid medium, wherein the second air opening is configured to be covered before the first air opening.

17. An off-road vehicle having an engine assembly, a continuously variable transmission (CVT) clutch assembly having a housing, and a duct valve for the clutch assembly, wherein the duct valve comprises a first duct, a first valve cage having a first side opening, a second duct, and a second valve cage having a second side opening.

18. The vehicle of claim 17, wherein the first duct is coupled to the housing of the CVT clutch assembly and configured to extend towards a first side of the vehicle and the second duct is coupled with the housing of the clutch assembly and configured to extend towards a second side, opposite to the first side, of the vehicle.

19. The vehicle of claim 18, wherein the second side opening is lower than the first side opening.

20. The vehicle of claim 18, wherein the first valve cage is configured to hold a first floatable element, and the second valve cage is configured to hold a second floatable element, wherein the first floatable element and the second floatable elements are configured to have a first buoyancy and a second buoyancy, respectively, the first floatable element and the second floatable element configured to displace towards a first top surface of the first valve cage and a second top surface of the second valve cage, respectively, according to a liquid level when the respective valve cages are partially immersed in a liquid medium.
